(19) United States
(12) Patent Application Publication
(10) Pub. No.: US 2004/0245692 A1
(43) Pub. Date: Dec. 9, 2004

(54) Bar clamp

(76) Inventors: Robert L. Brass, Washington, CT (US); Steven W. Lewis, Woodbury, CT (US)

Correspondence Address: IRA S. DORMAN, Suite 200, 330 Roberts Street, East Hartford, CT, 06108, US

(21) Appl. No.: 10/879,314

(22) Filed: Jun. 29, 2004

Related U.S. Application Data
(63) Continuation-in-part of application No. 10/456,357, filed on Jun. 5, 2003.

(51) Int. Cl. B25B 1/00

(52) U.S. Cl. 269/3

(57) ABSTRACT

A bar clamp includes a spring that serves to prevent rearward displacement of the jaw in reaction to the application of clamping force, and a bar-engaging element that allows free descent of the adjustable jaw under the force of gravity.

### CROSS REFERENCE TO RELATED APPLICATION

This application is a continuation-in-part of copending U.S. application Ser. No. 10/456,357, filed Jun. 5, 2003, the entire specification of which is incorporated hereinto by reference thereto.

### BACKGROUND OF THE INVENTION

Bar clamps are widely used by carpenters, furniture builders, and others involved in woodworking activities, particularly when clamping forces must be applied across relatively wide expanses for fastening workpieces together, e.g., by gluing. Bar clamps conventionally consist of a stationary jaw member, permanently or disengageably affixed to a rectilinear bar, and an adjustable head or jaw member mounted on the bar for movement into positions to cooperate with the fixed jaw, with clamping normally being effected by operation of a clamping screw. Representative of the patent art in the field is Novak U.S. Pat. No. 5,192,060.

Mounting of the adjustable jaw for free sliding movement on the bar permits it to be brought quickly into position against the workpiece and to enable quick opening of the clamp, as through mere force of gravity. Measures must be taken however to accommodate, or to overcome, impediments to free movement in such a bar clamp while, at the same time, ensuring that rearward displacement of the adjustable jaw member does not undersirably occur in reaction to the application of forwardly directed clamping forces.

### SUMMARY OF THE INVENTION

Accordingly, it is a broad object of the present invention to provide a novel bar clamp having an adjustable jaw member mounted on the bar for free sliding movement in both directions, in which displacement away from the stationary jaw member, in reaction to the application of clamping force, is prevented.

It is also an object of the invention to provide such a bar clamp which is constructed to readily enable its own clamped mounting in a supporting unit, and which is of relatively incomplex and inexpensive design, construction, and manufacture.

It has now been found that certain of the foregoing and related objects of the invention are attained by the provision of a bar clamp comprising a stationary jaw member having a first, rearwardly facing clamping portion thereon; a rectilinear bar affixed to the stationary jaw member and extending rearwardly therefrom; and a movable jaw member slidably mounted on the bar rearwardly of the stationary jaw member and having support structure, and a forwardly facing second clamping portion, thereon. A clamping arm includes a lower portion having structure defining a passage through which the bar of the clamp passes, such that the clamping arm is slidably and tiltably mounted on the bar and can bindingly engage the bar to thereby prevent movement of the clamping arm, at least in the rearward direction and when the clamping arm is titled rearwardly. Biasing means is operatively disposed to act on the support structure of the movable jaw member and to exert a rearward tilting force on the clamping arm, and an adjustable, force-generating member is mounted on an upper portion of the clamping arm for operative engagement with the movable jaw member to apply clamping force thereto. The biasing means functions to ensure that the passage-defining structure of the clamping arm will bindingly engage the bar, and thereby to ensure that the force-generating member will be effective to apply clamping force to the movable jaw member.

The first and second clamping portions of the jaw members will normally have mutually confronting clamping faces thereon, and the support structure of the movable jaw member will usually be spaced rearwardly from the second clamping portion thereof, with the biasing means disposed effectively between the support structure and the clamping arm. The movable jaw member will usually comprise a housing that provides both the second clamping portion and also the support structure, and that defines an interior space in which are disposed both the biasing means and also at least the lower portion of the clamping arm. The biasing means will preferably take the form of a coil spring slidably mounted on the bar between the clamping arm and the support structure.

In most embodiments, the force-generating member employed will comprise a clamping screw that is threadably mounted in the upper portion of the clamping arm and that has a rearwardly projecting handle portion for manual adjustment of the distance of projection of the forwardly projecting portion thereof. The clamping arm will preferably have an element thereon for slidably engaging the bar so as to limit the forward tilt of the clamping arm, such an element desirably being in the form of a nose portion that projects generally forwardly from the clamping arm at a location lying upwardly adjacent the passage therethrough. By preventing the passage-defining structure of the clamping arm from binding on the bar when the clamping arm is subjected to a forward tilting force, forward movement of the movable jaw member toward the stationary jaw member is ensured. At least one of the jaw members will desirably have an engagement flange thereon for clamped mounting of the bar clamp itself in a supporting unit.

### BRIEF DESCRIPTION OF THE DRAWINGS

FIG. 1 of the drawings is a perspective view of a bar clamp embodying the present invention;

FIG. 2 is a side elevational view of the bar clamp;

FIGS. 3 and 4 are plan and bottom views of the bar clamp, respectively;

FIGS. 5 and 6 are front and rear views of the bar clamp, respectively;

FIG. 7 is an exploded perspective view of the bar clamp;

FIG. 8 is a sectional view of the bar clamp, taken along line 8-8 in FIG. 3, showing the adjustable jaw member moved to a position proximate a workpiece; and

FIG. 9 is a second sectional view showing, in phantom line, the adjustable jaw member of the bar clamp moved by the clamping screw to a position of clamping engagement with the workpiece, the clamping arm being canted by action of the coil spring into binding engagement with the mounting bar.

### DETAILED DESCRIPTION OF THE PREFERRED AND ILLUSTRATED EMBODIMENTS

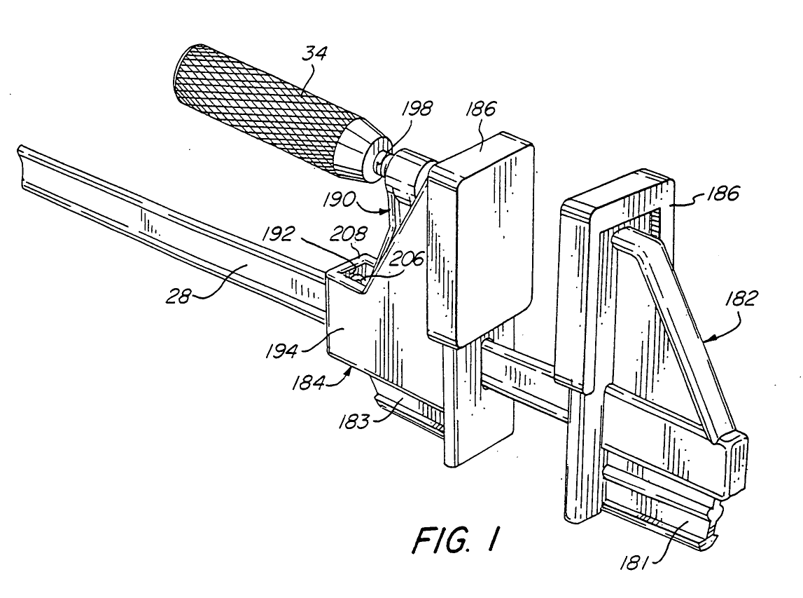

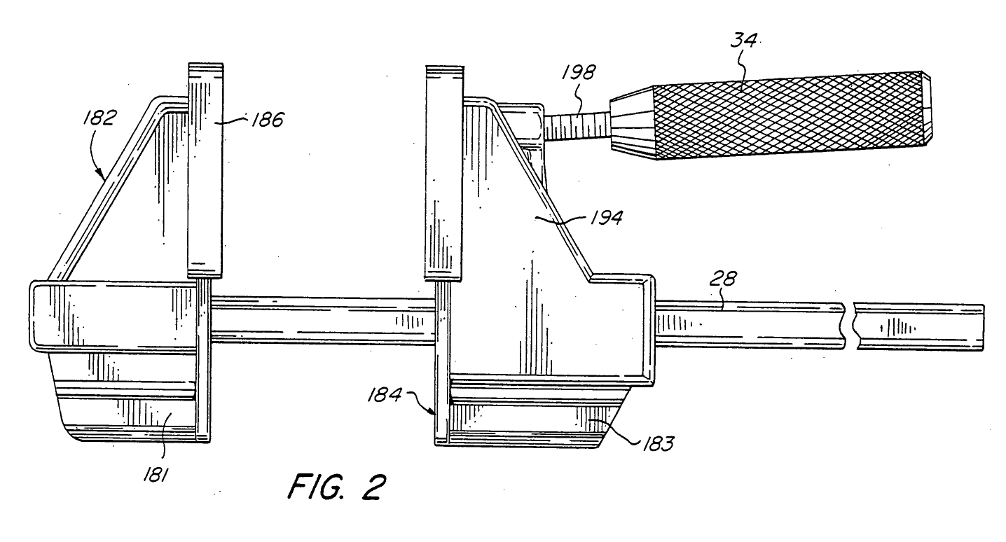

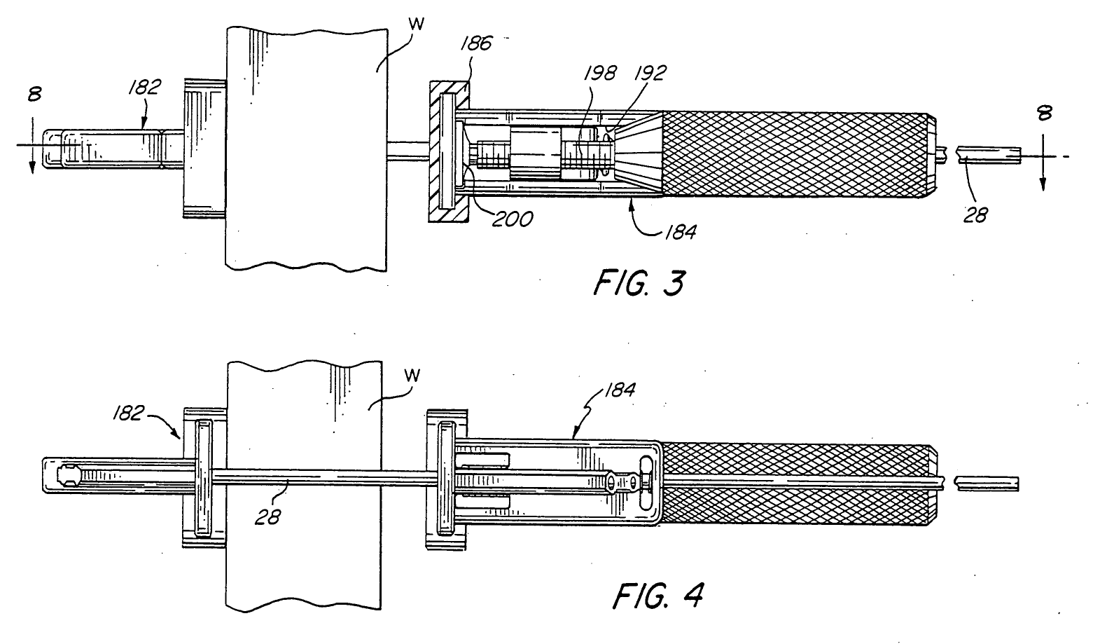

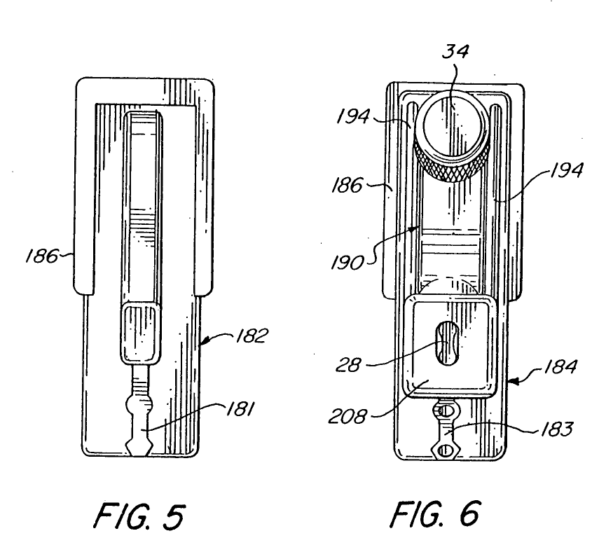

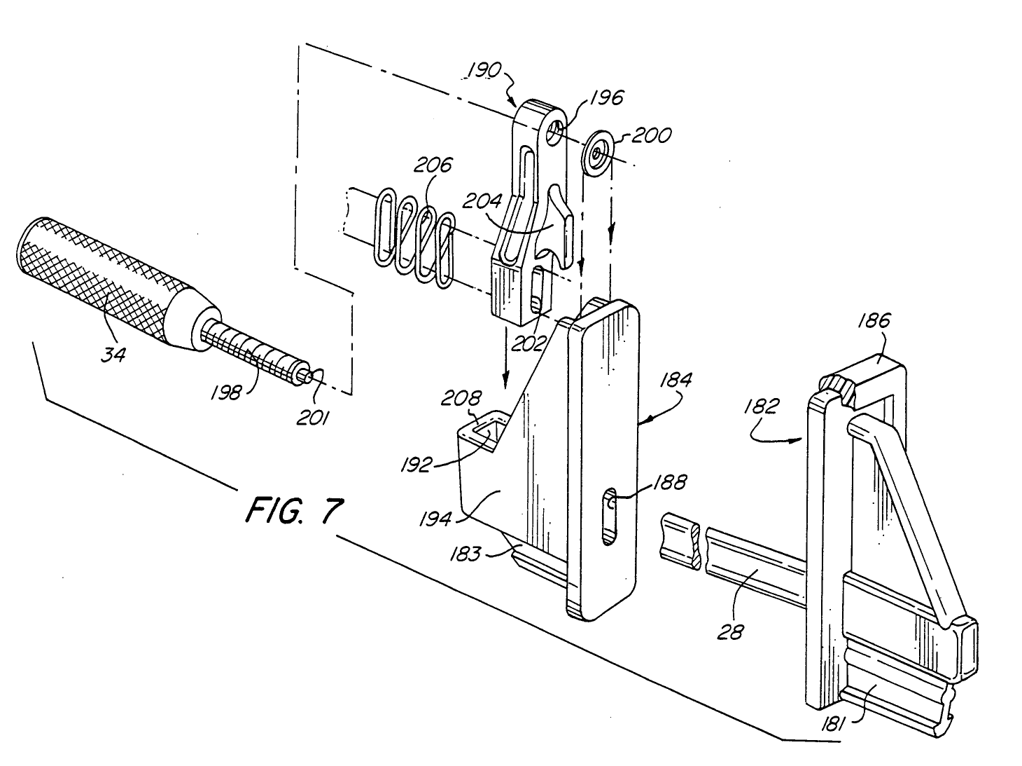

Turning now in detail to FIGS. 1 through 9 of the drawings, therein illustrated is a bar clamp embodying the present invention and consisting of a fixed, or stationary, jaw and a movable, or adjustable, jaw, generally designated by the numerals 182 and 184 respectively. The jaw 182 is permanently affixed to the end of the rectilinear bar 28, which is in turn slidably received in the passage 188 of the movable jaw housing. The jaws 182, 184 have flanges 181 and 183 thereon, bearing raised rib structures and providing engagement portions for ready mounting of the clamp in a vise or similar clamping unit (such as the connector assemblies described in International Publication No. WO 2004/001234 A2 and A3 [PCT/US2003//020056], and in U.S. design patent D491795, the disclosures of which are incorporated hereinto by reference thereto); protective plastic sleeves 186 are mounted on confronting portions of the jaws to provide cushioned contact surfaces.

A clamping arm, generally designated by the numeral 190, is received in the space 192 defined between the walls 194 of the housing of which the movable jaw 184 is comprised. The arm 190 has a threaded aperture 196 at its upper end, to receive the clamping screw 198, and a contact disc 200 is rotatably mounted on the stud 201 that projects from the tip on the forward portion of the screw 198. A passage 202 of oblong cross section extends through the lower end portion of the arm 190, and a hooked nose element 204 projects forwardly therefrom between the aperture 196 and the passage 202. An oblong coil spring 206 is slidably mounted on the bar 28 in the space between the arm 190 and the back wall 208 of the jaw housing.

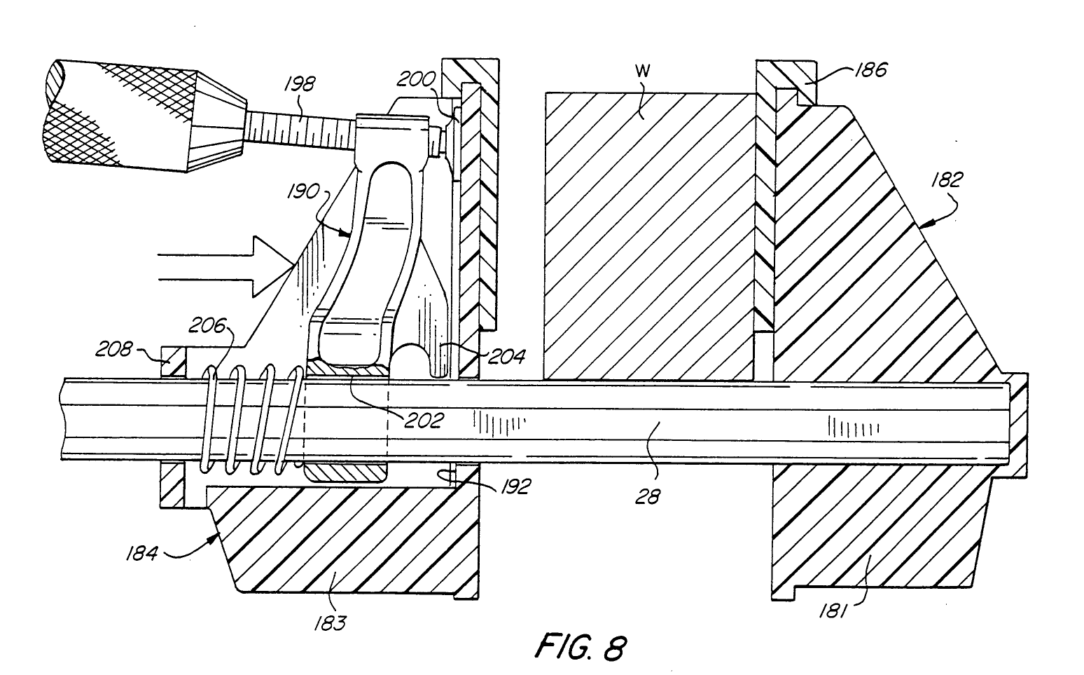

In operation, and as depicted in FIG. 8, the movable jaw 182 of the bar clamp is moved forwardly on the bar 28 until it substantially contacts (or actually contacts) the workpiece W. When used in vertical orientation, with the movable jaw 182 disposed upwardly above the workpiece, the jaw can be permitted to simply slide into contact with the workpiece under the force of gravity, then requiring only limited rotation of the handle 34 to effect clamping. The nose element 204 is positioned to contact, and bear slidably upon, the bar 28 when the arm 190 is subjected to forward tilting influences, thereby preventing binding engagement of the bar by the surface defining the passage 202 and hence ensuring that such free descent occurs.

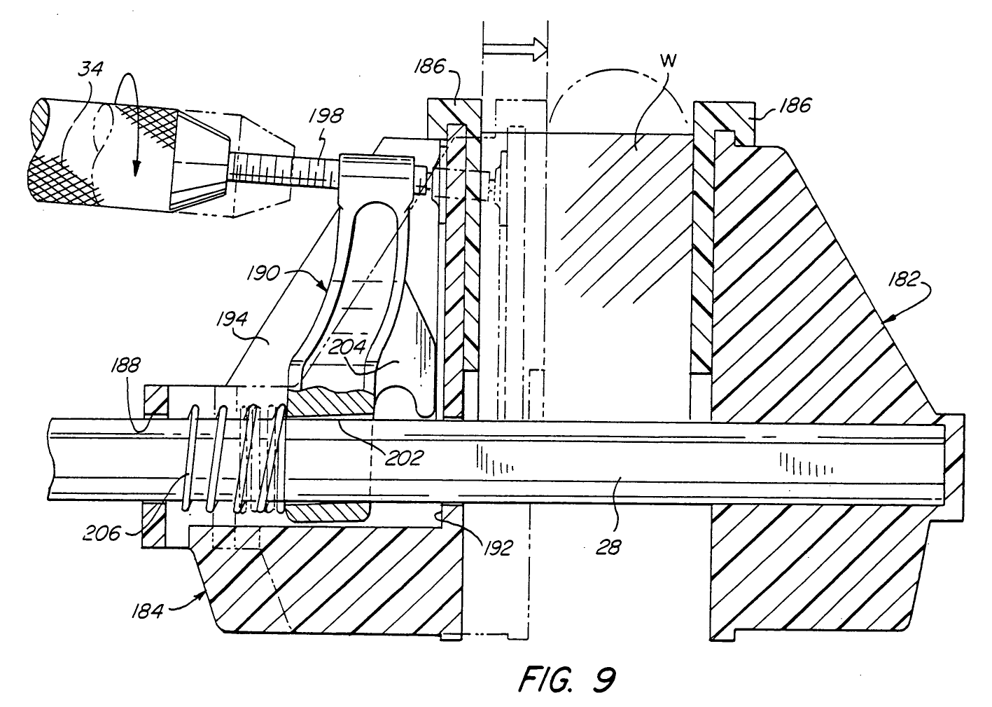

Conversely, and as depicted in FIG. 9, when the coil spring 206 (acting against the back wall 208) is brought to bear upon the lower portion of the clamping arm 190 it exerts a forward bias thereupon and cants the arm rearwardly so as to cause the surface defining the upper part of the passage 202 to engage and bind upon the confronting edge of the bar 28. This prevents displacement of the arm 190 rearwardly along the bar (unless the biasing force is relieved) in reaction to the force applied by the clamping screw 198, and ensures that the movable jaw will advance against the workpiece W to provide the clamping force desired.

Thus, it can be seen that the present invention provides a novel bar clamp in which the adjustable jaw member is mounted on the bar for free sliding movement in both directions, but in which undesirable displacement of the jaw member, in reaction to the application of clamping force, is prevented. The clamp is of relatively incomplex design and construction, and of relatively facile and inexpensive manufacture.

Having thus described the invention, what is claimed is:

1. A bar clamp comprising: a stationary jaw member having a first, rearwardly facing clamping portion thereon; a rectilinear bar affixed to said stationary jaw member and extending rearwardly therefrom; a movable jaw member slidably mounted on said bar rearwardly of said stationary jaw member, said movable jaw member having a forwardly facing second clamping portion thereon and including support structure; a clamping arm having a lower portion with structure defining a passage therethrough, said bar passing through said passage with said clamping arm slidably and tiltably mounted on said bar and disposed rearwardly of said second clamping portion, said passage-defining structure being effective to bindingly engage said bar, and thereby prevent movement of said clamping arm, at least in the rearward direction and when said clamping arm is titled rearwardly; biasing means operatively disposed to act on said support structure of said movable jaw member and to exert a rearward tilting force on said clamping arm; and an adjustable, force-generating member operatively mounted on an upper portion of said clamping arm and having a portion projecting a variable distance forwardly therefrom for operative engagement with said movable jaw member to apply clamping force thereto, said biasing means functioning to ensure binding engagement of said passage-defining structure with said bar, when said clamping arm is forceably engaged with said biasing means and is titled rearwardly, to thereby ensure that said force-generating member effectively applies such clamping force to said movable jaw member.

2. The bar clamp of claim 1 wherein said first and second clamping portions of said jaw members have mutually confronting clamping faces thereon.

3. The bar clamp of claim 1 wherein said support structure is spaced rearwardly from said second clamping portion of said movable jaw member, and wherein said biasing means is disposed effectively between said support structure and said clamping arm.

4. The bar clamp of claim 1 wherein said movable jaw member comprises a housing providing both said second clamping portion and also said support structure, said housing defining an interior space in which at least said lower portion of said clamping arm, and said biasing means, are disposed.

5. The bar clamp of claim 1 wherein said biasing means comprises a coil spring slidably mounted on said bar between said clamping arm and said support structure.

6. The bar clamp of claim 1 wherein said force-generating member comprises a clamping screw threadably mounted in said upper portion of said clamping arm and having a rearwardly projecting handle portion thereon for manual adjustment of the distance of projection of said forwardly projecting portion thereof.

7. The bar clamp of claim 1 wherein said clamping arm has a bar-engaging element thereon for slidably engaging said bar and thereby limiting the forward tilt of said clamping arm so as to prevent said passage-defining structure from binding on said bar when said clamping arm is subjected to forward tilting force, said bar-engaging element thereby enabling free forward movement of said movable jaw member toward said stationary jaw member.

8. The bar clamp of claim 7 wherein said bar-engaging element is a nose portion that projects generally forwardly from said clamping arm at a location lying upwardly adjacent said passage therethrough.

9. The bar clamp of claim 1 wherein at least one of said jaw members has an engagement flange thereon for clamped mounting in a supporting unit.

10. A bar clamp comprising: a stationary jaw member having a first, rearwardly facing clamping portion thereon; a rectilinear bar affixed to said stationary jaw member and extending rearwardly therefrom; a movable jaw member slidably mounted on said bar rearwardly of said stationary jaw member, said movable jaw member having a forwardly facing second clamping portion thereon and including support structure spaced rearwardly from said second clamping portion of said movable jaw member; a clamping arm having a lower portion with structure defining a passage therethrough, said bar passing through said passage with said clamping arm slidably and tiltably mounted on said bar and disposed rearwardly of said second clamping portion, said passage-defining structure being effective to bindingly engage said bar, and thereby prevent movement of said clamping arm, at least in the rearward direction and when said clamping arm is titled rearwardly; biasing means comprising a coil spring slidably mounted on said bar between said clamping arm and said support of said movable jaw member and operatively disposed to act on said support structure to exert a rearward tilting force on said clamping arm; and an adjustable, force-generating member operatively mounted on an upper portion of said clamping arm and having a portion projecting a variable distance forwardly therefrom for operative engagement with said movable jaw member to apply clamping force thereto, said biasing means functioning to ensure binding engagement of said passage-defining structure with said bar, when said clamping arm is forceably engaged with said biasing means and is titled rearwardly, to thereby ensure that said force-generating member effectively applies such clamping force to said movable jaw member.

11. The bar clamp of claim 10 wherein said movable jaw member comprises a housing providing both said second clamping portion and also said support structure, said housing defining an interior space in which at least said lower portion of said clamping arm, and said coil spring, are disposed.

12. A bar clamp comprising: a stationary jaw member having a first, rearwardly facing clamping portion thereon; a rectilinear bar affixed to said stationary jaw member and extending rearwardly therefrom; a movable jaw member slidably mounted on said bar rearwardly of said stationary jaw member, said movable jaw member having a forwardly facing second clamping portion thereon and including support structure; a clamping arm having a lower portion with structure defining a passage therethrough, said bar passing through said passage with said clamping arm slidably and tiltably mounted on said bar and disposed rearwardly of said second clamping portion, said passage-defining structure being effective to bindingly engage said bar, and thereby prevent movement of said clamping arm, at least in the rearward direction and when said clamping arm is titled rearwardly, said clamping arm also having a bar-engaging element thereon for slidably engaging said bar and thereby limiting the forward tilt of said clamping arm so as to prevent said passage-defining structure from binding on said bar when said clamping arm is subjected to forward tilting force, said bar-engaging element thereby enabling free forward movement of said movable jaw member toward said stationary jaw member; biasing means operatively disposed to act on said support structure of said movable jaw member and to exert a rearward tilting force on said clamping arm; and an adjustable, force-generating member operatively mounted on an upper portion of said clamping arm and having a portion projecting a variable distance forwardly therefrom for operative engagement with said movable jaw member to apply clamping force thereto, said biasing means functioning to ensure binding engagement of said passage-defining structure with said bar, when said clamping arm is forceably engaged with said biasing means and is titled rearwardly, to thereby ensure that said force-generating member effectively applies such clamping force to said movable jaw member.

13. The bar clamp of claim 12 wherein said bar-engaging element is a nose portion that projects generally forwardly from said clamping arm at a location lying upwardly adjacent said passage therethrough.
